(19) United States
(12) Patent Application Publication
(10) Pub. No.: US 2015/0199717 A1
(43) Pub. Date: Jul. 16, 2015

(54) SOCIAL NETWORKING ADVERTISING PROCESS

(71) Applicant: DEMANDX LLC, Midland, TX (US)

(72) Inventors: Jared Davis, Midland, TX (US); Fred Darnell, Charlotte, NC (US)

(21) Appl. No.: 14/598,610

(22) Filed: Jan. 16, 2015

Related U.S. Application Data
(60) Provisional application No. 61/928,124, filed on Jan. 16, 2014.

(51) Int. Cl. G06Q 30/02; G06Q 50/00

(52) U.S. Cl. CPC G06Q 30/0255; G06Q 50/01; G06Q 30/0277

(57) ABSTRACT

A computer-implemented method and computing system for receiving one or more advertising parameters for use in a social networking system, wherein the one or more parameters are received from a brand owner. The method may include receiving a response from a user of the social networking system indicating enrollment in advertisement generation associated with a social networking page of the user. The method may also include determining a connection between the brand owner and the user of the social networking system based upon, at least in part, at least one of the one or more parameters and the response. The method may further include identifying an advertisement based upon at least one of the one or more parameters and the response and transmitting the advertisement to the social networking page of the user.

### CROSS-REFERENCE TO RELATED APPLICATIONS

This application claims the benefit of U.S. Provisional Application having Ser. No. 61/928,124, filed Jan. 16, 2014, of which the entire contents are incorporated herein by reference.

### TECHNICAL FIELD

This disclosure relates to advertising and, more particularly, to a system and method for advertising within a social network.

### BACKGROUND

A social network (e.g., FACEBOOK™, MYSPACE™, LINKEDIN™, TWITTER™, GOOGLE+™, etc.) may refer to an online system that provides a forum for geographically separated users to interact with one another, where those users have defined a relationship between one another. Users may control who may view their information by identifying particular relationships with other users, and may also find new users from the group of other people who are “friends” of their own friends. Social networks may be aimed at different types of social interaction, such as friendship and business networking. A user of a social network may have a profile page (e.g., a web page on the social network) that provides information about the user to other users of the social network. A profile may include information regarding a user's acquaintance relationships (e.g., friends, colleagues, schoolmates, etc.) on the social network. A profile page may also include photos of the user or the user's interests.

### SUMMARY OF DISCLOSURE

In a first implementation, a computer-implemented method includes receiving one or more advertising parameters for use in a social networking system, wherein the one or more parameters are received from a brand owner. The method may include receiving a response from a user of the social networking system indicating enrollment in advertisement generation associated with a social networking page of the user. The method may also include determining a connection between the brand owner and the user of the social networking system based upon, at least in part, at least one of the one or more parameters and the response. The method may further include identifying an advertisement based upon at least one of the one or more parameters and the response and transmitting the advertisement to the social networking page of the user.

One or more of the following features may be included. In some embodiments, the response may indicate one or more user preferences regarding where the advertisement is placed on the social networking page of the user. The response may identify one or more brand owners for inclusion or exclusion on the social networking page of the user. The one or more advertising parameters may include target audience demographic information. The method may include determining a value associated with the social networking page of the user based upon, at least in part, the target audience demographic information. The method may further include determining a compensation amount based upon the value associated with the social networking page of the user. The method may also include transmitting a second advertisement to a contact of the user, wherein the second advertisement is based upon, at least in part, demographic information associated with at least one of the user and the contact.

In another implementation, a computing system includes a processor and memory configured to perform operations including receiving one or more advertising parameters for use in a social networking system, wherein the one or more parameters are received from a brand owner. Operations may include receiving a response from a user of the social networking system indicating enrollment in advertisement generation associated with a social networking page of the user. Operations may also include determining a connection between the brand owner and the user of the social networking system based upon, at least in part, at least one of the one or more parameters and the response. Operations may further include identifying an advertisement based upon at least one of the one or more parameters and the response and transmitting the advertisement to the social networking page of the user.

One or more of the following features may be included. In some embodiments, the response may indicate one or more user preferences regarding where the advertisement is placed on the social networking page of the user. The response may identify one or more brand owners for inclusion or exclusion on the social networking page of the user. The one or more advertising parameters may include target audience demographic information. Operations may include determining a value associated with the social networking page of the user based upon, at least in part, the target audience demographic information. Operations may further include determining a compensation amount based upon the value associated with the social networking page of the user. Operations may also include transmitting a second advertisement to a contact of the user, wherein the second advertisement is based upon, at least in part, demographic information associated with at least one of the user and the contact.

In another implementation, a non-transitory computer-readable storage medium having stored thereon instructions that when executed by a machine result in one or more operations is provided. Operations may include receiving one or more advertising parameters for use in a social networking system, wherein the one or more parameters are received from a brand owner. Operations may include receiving a response from a user of the social networking system indicating enrollment in advertisement generation associated with a social networking page of the user. Operations may also include determining a connection between the brand owner and the user of the social networking system based upon, at least in part, at least one of the one or more parameters and the response. Operations may further include identifying an advertisement based upon at least one of the one or more parameters and the response and transmitting the advertisement to the social networking page of the user.

One or more of the following features may be included. In some embodiments, the response may indicate one or more user preferences regarding where the advertisement is placed on the social networking page of the user. The response may identify one or more brand owners for inclusion or exclusion on the social networking page of the user. The one or more advertising parameters may include target audience demographic information. Operations may include determining a value associated with the social networking page of the user based upon, at least in part, the target audience demographic information. Operations may further include determining a compensation amount based upon the value associated with the social networking page of the user.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes social networking advertising process according to an embodiment of the present disclosure;

FIG. 2 is a flowchart of social networking advertising process of FIG. 1 according to an embodiment of the present disclosure;

FIG. 3 is a diagrammatic view of a social networking advertising process according to an embodiment of the present disclosure;

FIG. 4A is a diagrammatic view of a social networking advertising process according to an embodiment of the present disclosure;

FIG. 4B is a diagrammatic view of a social networking advertising process according to an embodiment of the present disclosure;

FIG. 4C is a diagrammatic view of a social networking advertising process according to an embodiment of the present disclosure;

FIG. 5 is a diagrammatic view of a social networking advertising process according to an embodiment of the present disclosure;

FIG. 6 is a diagrammatic view of a social networking advertising process according to an embodiment of the present disclosure; and

FIG. 7 is a diagrammatic view of a computing device according to an embodiment of the present disclosure.

Like reference symbols in the various drawings indicate like elements.

### DETAILED DESCRIPTION OF THE EMBODIMENTS

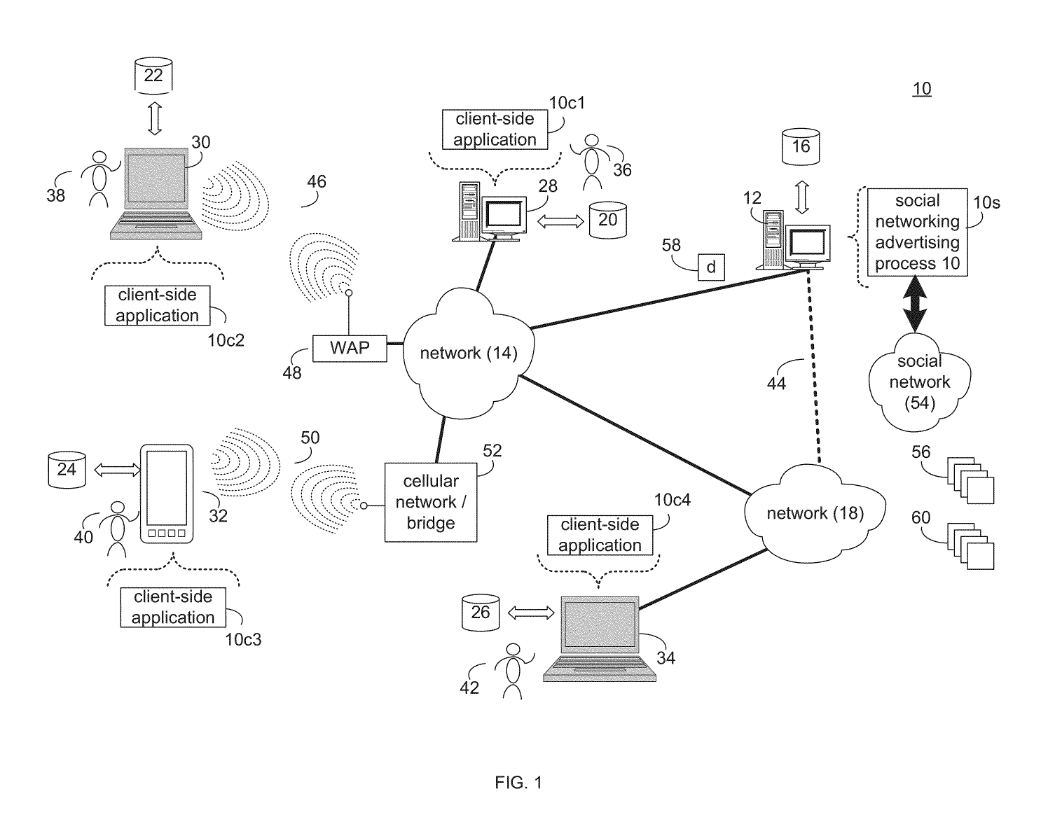

Referring to FIG. 1, there is shown social networking advertising process 10. For the following discussion, it is intended to be understood that social networking advertising process 10 may be implemented in a variety of ways. For example, social networking advertising process 10 may be implemented as a server-side process, a client-side process, or a server-side/client-side process. Any user, if they so choose, may elect to disable any or all of the features associated with social networking advertising process 10.

For example, social networking advertising process 10 may be implemented as a purely server-side process via social networking advertising process 10s. Alternatively, social networking advertising process 10 may be implemented as a purely client-side process via one or more of client-side application 10c1, client-side application 10c2, client-side application 10c3, and client-side application 10c4. Alternatively still, social networking advertising process 10 may be implemented as a server-side/client-side process via social networking advertising process 10s in combination with one or more of client-side application 10c1, client-side application 10c2, client-side application 10c3, and client-side application 10c4.

Accordingly, social networking advertising process 10 as used in this disclosure may include any combination of social networking advertising process 10s, client-side application 10c1, client-side application 10c2, client-side application 10c3, and client-side application 10c4.

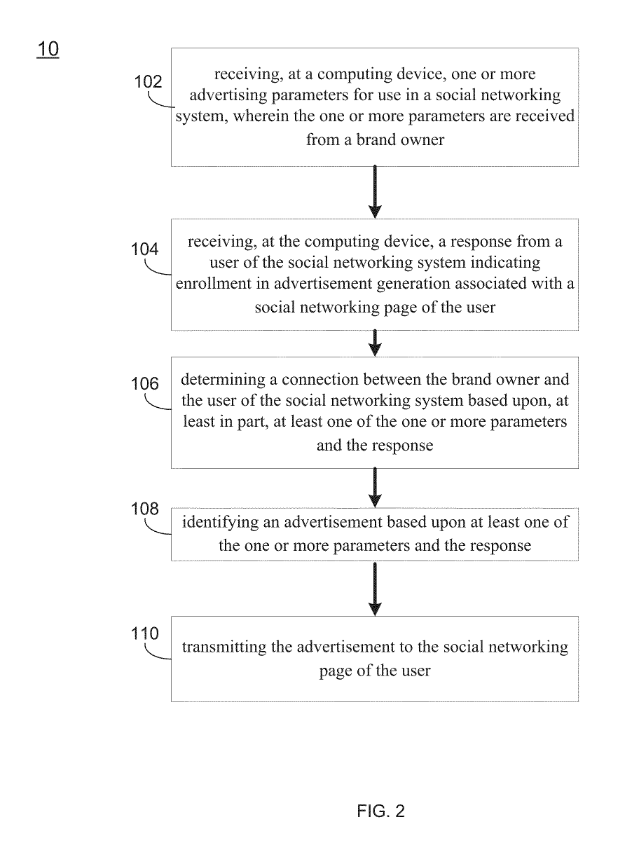

Referring also to FIG. 2 and as will be discussed below in greater detail, social networking advertising process 10 may include receiving (102), at a computing device, one or more advertising parameters for use in a social networking system, wherein the one or more parameters are received from a brand owner. Social networking advertising process 10 may further include receiving (104), at the computing device, a response from a user of the social networking system indicating enrollment in advertisement generation associated with a social networking page of the user. Social networking advertising process 10 may also include determining (106) a connection between the brand owner and the user of the social networking system based upon, at least in part, at least one of the one or more parameters and the response. Social networking advertising process 10 may also include identifying (108) an advertisement based upon at least one of the one or more parameters and the response and transmitting (110) the advertisement to the social networking page of the user.

Social networking advertising process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a dedicated network device.

The instruction sets and subroutines of social networking advertising process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to a web browser, a game console user interface, a television user interface, or a specialized application (e.g., an application running on a mobile platform). The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, desktop computer 28, laptop computer 30, data-enabled, cellular telephone 32, notebook computer 34, a server computer (not shown), a personal gaming device (not shown), a data-enabled television console (not shown), a personal music player (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access social networking advertising process 10 directly through network 14 or through secondary network 18. Further, social networking advertising process 10 may be accessed through secondary network 18 via link line 44.

The various client electronic devices (e.g., client electronic devices 28, 30, 32, 34) may be directly or indirectly coupled to network 14 (or network 18). For example, desktop computer 28 is shown directly coupled to network 14 via a hardwired network connection. Laptop computer 30 is shown wirelessly coupled to network 14 via wireless communication channel 46 established between laptop computer 30 (respectively) and wireless access point (i.e., WAP) 48, which is shown directly coupled to network 14. WAP 48 may be, for example, an IEEE 802.11a, 802.11b, 802.11g, 802.11n, Wi-Fi, and/or Bluetooth device that is capable of establishing wireless communication channel 46 between laptop computer 30 and WAP 48. Further, data-enabled, cellular telephone 32 is shown wirelessly coupled to network 14 via wireless communication channel 50 established between data-enabled, cellular telephone 32 and cellular network/bridge 52, which is shown directly coupled to network 14. Additionally, notebook computer 34 is shown directly coupled to network 18 via a hardwired network connection.

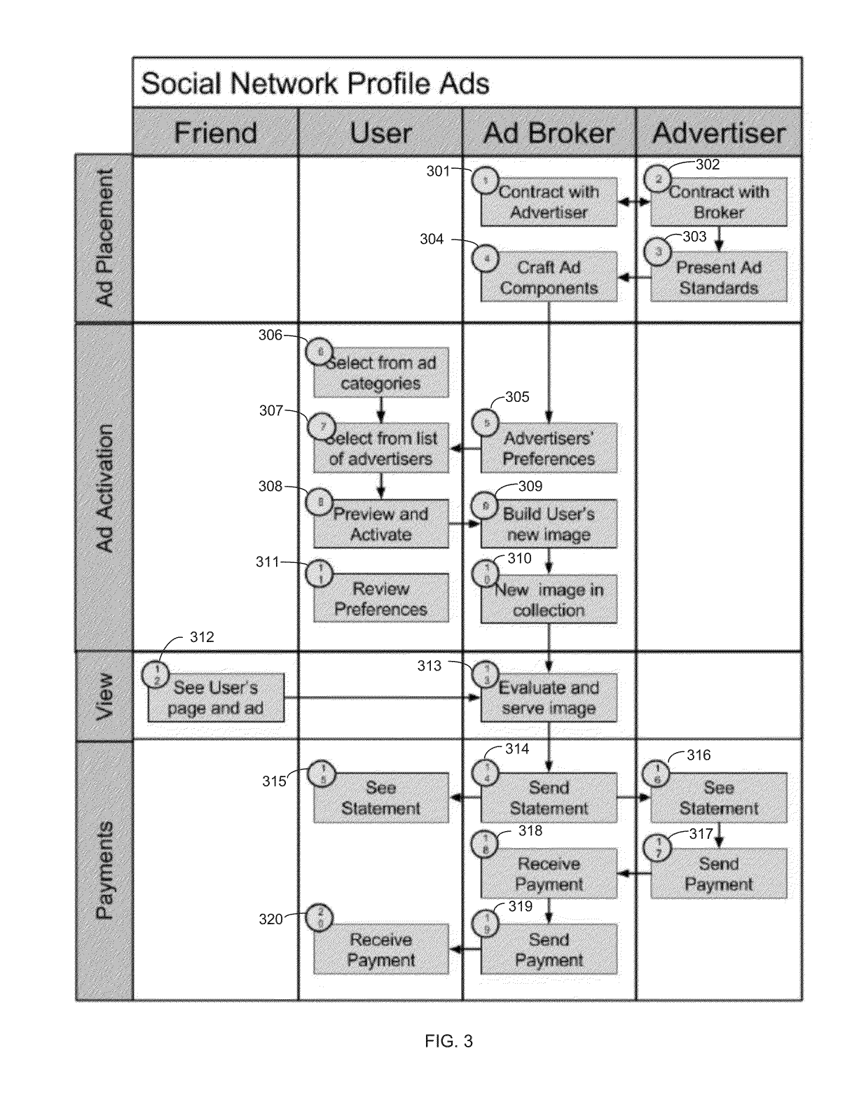

Referring now to FIGS. 3-6, various diagrams consistent with social networking advertising process 10 are provided. Embodiments of social networking advertising process 10 may allow a user to elect to display one or more social network profile advertisements on his/her social networking page. Accordingly, embodiments of social networking advertising process 10 may be used to increase brand awareness via social network user endorsement.

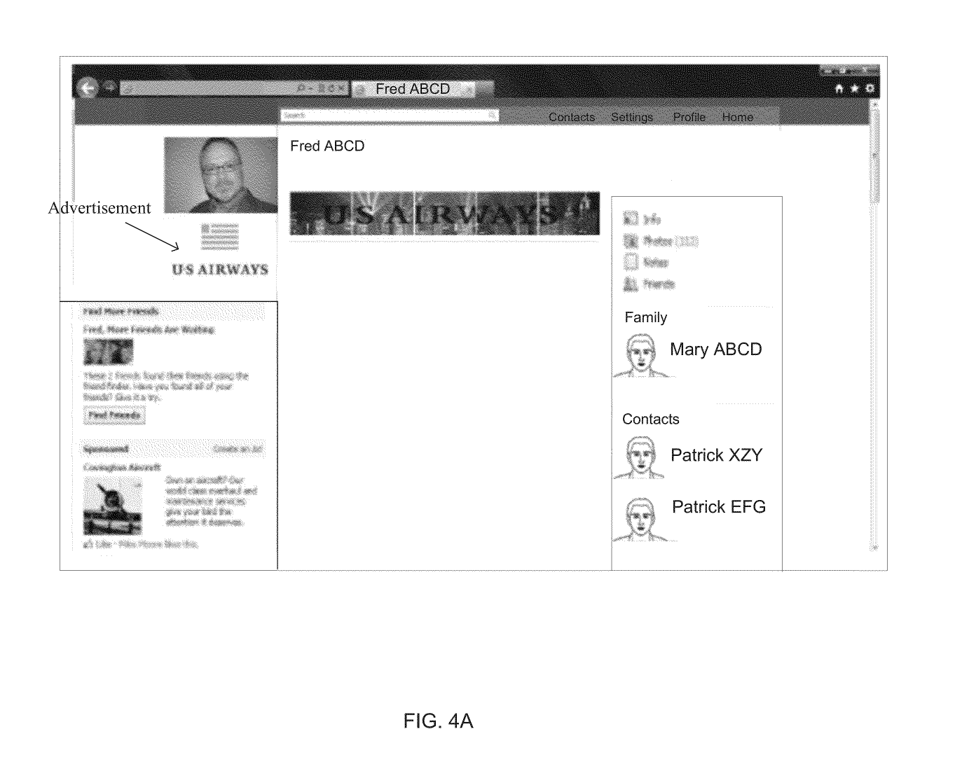

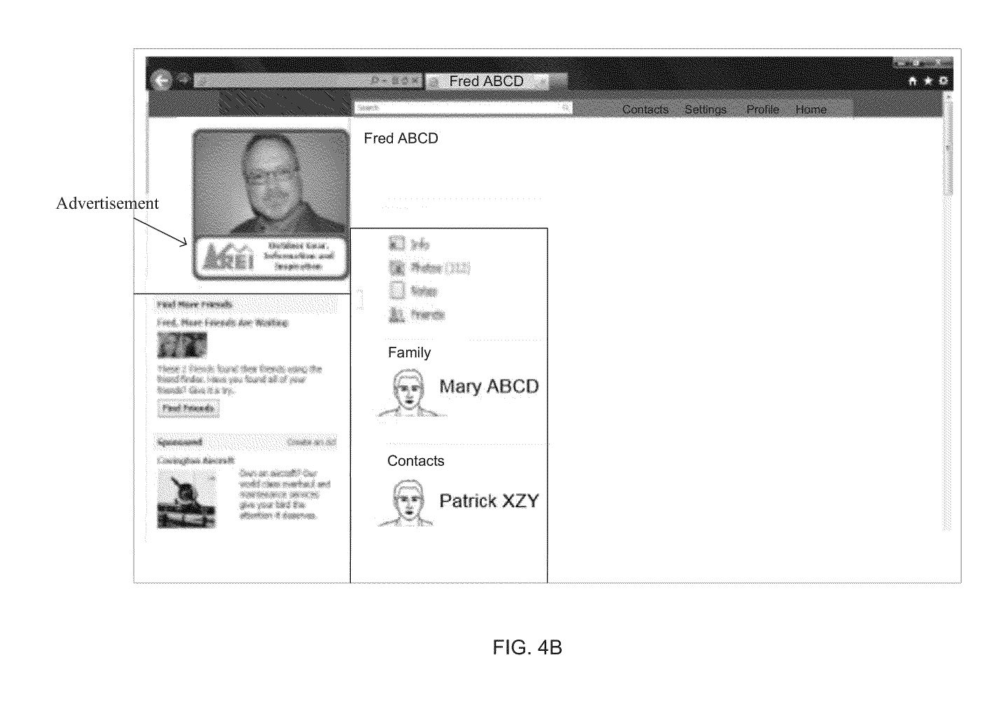

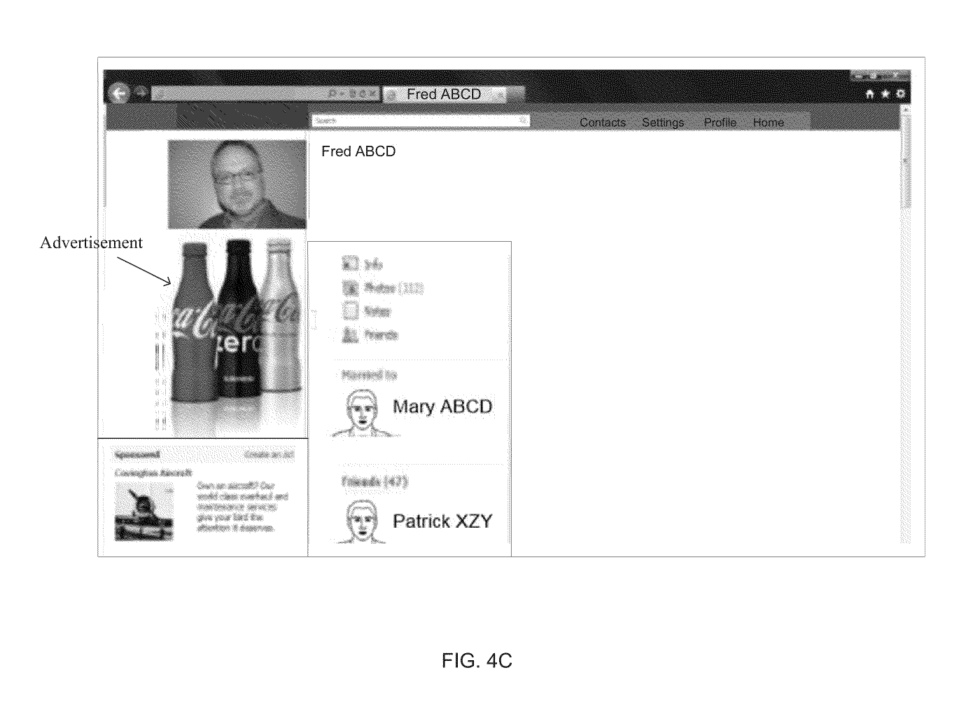

In some embodiments, and referring to FIGS. 3-4, a social network user may endorse a brand by allowing that brand to replace the user's normal profile photo and/or avatar with a modified version that includes the brands mark(s) or imagery. Accordingly, social networking advertising process 10 may allow for placement of an advertisement as a modified profile image or avatar that includes third-party branding. As used herein, the term “user” may include, but is not limited to, a social network user, game player, company and/or individual utilizing Social Network Profile Advertisements. The terms “contact”, “viewer”, or “friend” may refer to a social network user viewing a “User's” profile and/or the advertisement on display. The terms “broker” may refer to the owner or licensor of the social network profile advertising system. The term “advertiser” may indicate the brand owner.

In the context of FIG. 1, and the embodiment included herein, the broker may be associated with server computing device 12 and may be connected with the various users shown as well as with the advertiser via networks 14, 18, etc. In that type of arrangement, there may be multiple server devices such that the advertiser and broker each include their own respective server computing devices capable of communicating with one another and the users (and user's computing devices via networks 14, 18, etc.).

In some embodiments, the user of the social network may be compensated by either the advertiser and/or a third party broker who may be responsible for the management and display of the advertisement. For example, in some cases, the social network users may be paid per page view, advertisement selection, etc. Additionally and/or alternatively, rates of pay may be determined by an algorithm that calculates the value of each page view based on the demographics of the viewer as compared to the stated/targeted demographics of the brand's campaign. Accordingly, the advertisers may pay the operators of the social network profile advertising service (e.g., the broker).

Embodiments of social networking advertising process 10 may apply to any suitable medium. Some of these may include, but are not limited to, social network profile photos, social gaming avatars, cloud-based contact record profile images for companies and individuals, etc.

In operation, and with regard to placement of the advertisement, a broker may engage one or more advertisers to run advertisements for their brands on one or more social network sites. This may involve numerous contractual agreements 301, 302 as indicated in FIG. 3.

In some embodiments, the advertisers may describe the demographics of the target audience using one or more parameters, which may be received and used as an input to social networking advertising process 10. Some of these parameters may include, but are not limited to, interests, keywords, age, geographic location, language preferences, gender, age, etc. These preferences along with advertisement copy, and other constraints may be stored as part of social networking advertising process 10 as preferences and standards 303. In some embodiments, the broker may review, enhance, and prepare the advertising components for use and may activate the advertising campaign 304. The advertising campaign may now be available for selection by one or more users 305.

In some embodiments, social networking advertising process 10 may allow for activation of the advertisement using a number of methods. In this way, users may agree to supplant their user profile image, avatar, or other personal mark by opting-in to social networking advertising process 10 using an appropriate mechanism on their social network service.

In some embodiments, social networking advertising process 10 may provide a graphical user interface that may allow the user to define various preferences for categories and/or companies they are willing to endorse or are unwilling to endorse. For example, using such an interface, the user may be presented with a list of categories 306 and brands 307 from which to choose and rank. Some of these may include but are not limited to, outdoor, sports, food, beverage, autos, etc. Within each category, companies may be specifically included, excluded and/or ranked. Social networking advertising process 10 may allow the user to saves his/her preferences (e.g. using any of the storage devices shown in FIG. 1) and any and all advertisements matching their choices and the demographic of the viewer/friend may now be active 308.

In some embodiments, social networking advertising process 10 may be configured to pre-initialize images to be used for this user 309 and adds to a collection of available advertisement campaigns for this user 310. These choices may be used by social networking advertising process 10 to determine by algorithm 313 when, if, how often, and to whom the advertisement may be displayed.

In some embodiments, social networking advertising process 10 may be configured to allow for variations with respect to advertisement presentation and viewing. For example, when viewed by the user, their own profile picture may be displayed, framed and may include a link to indicate it is serving advertisements dynamically. By selecting the link, this may allow the user to see examples 311, 315 of each advertisement served and statistics summarizing counts, fit to target demographic, funds accumulated, etc.

Additionally and/or alternatively, when viewed by the viewer or friend of the user, social networking advertising process 10 may be configured to evaluate 313 the demographics of the viewer, the target demographics of each advertisement activated by the user, the time of day, the historical statistics of previous advertisements served and more, and serves up 312 the most relevant advertisement for the viewer. Advertisement views and all related data may be recorded for analysis and reporting.

In some embodiments, viewers may see different profile images for any given user. For example, viewer A when looking at user John Doe's social profile image might see a profile advertisement related to skiing, where viewer B might simultaneously see a profile advertisement related to motorcycles.

In some embodiments, social networking advertising process 10 may allow for various payment and accounting techniques. For example, on a periodic basis invoices may be sent by the broker to the advertiser 314, 316 and payments may be made 317 for the services provided. Periodically payments may be made by the broker to the users 319, 320 for endorsement of the advertisers' brands.

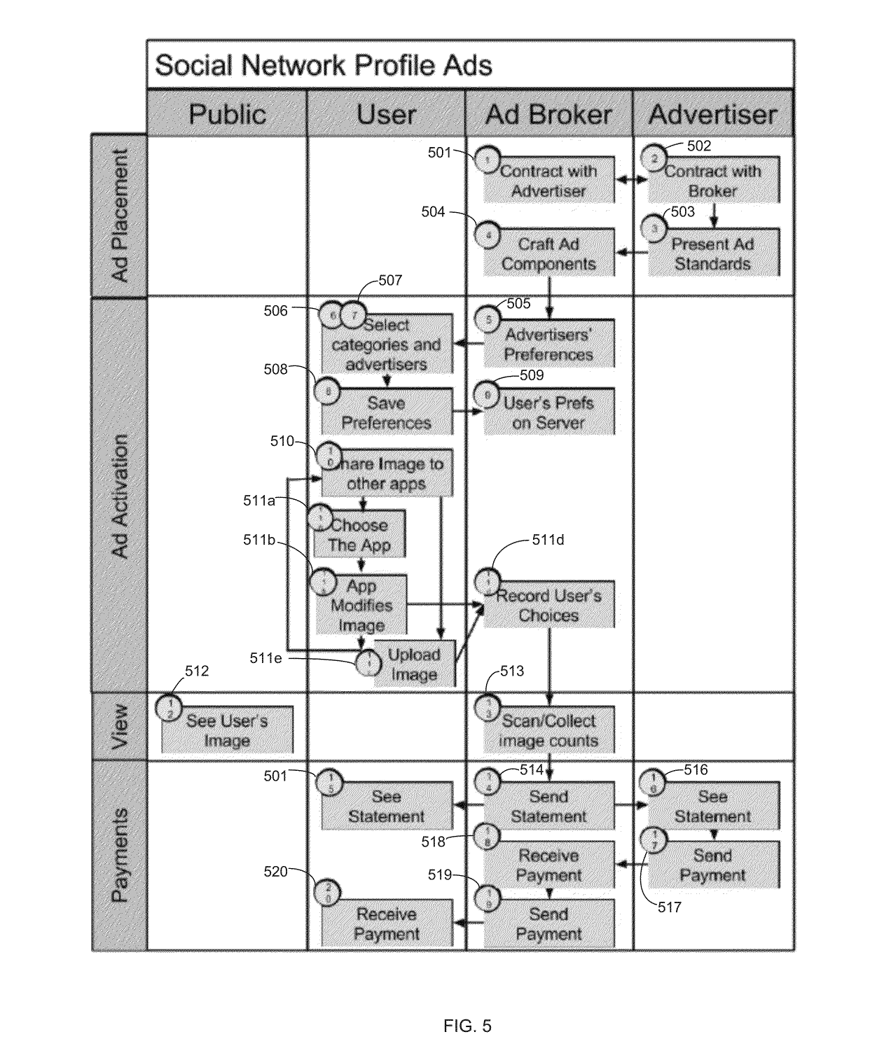

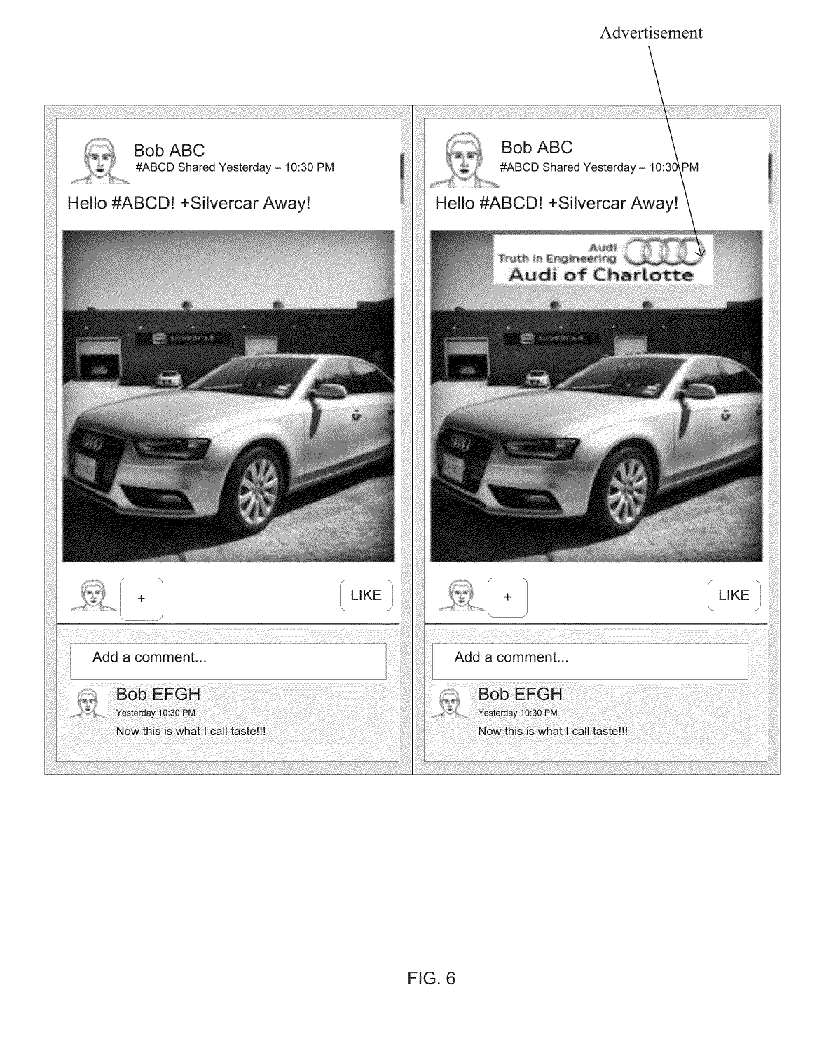

In some embodiments, and referring also to FIGS. 5-6, embodiments of social networking advertising process 10 may utilize any photos modified by the system for posting to a web-based service. As was discussed above with reference to FIGS. 3-4, these particular embodiments allowed for interfaces to the social network system to modify the user's profile photo for use as an advertisement brokered by social networking advertising process 10. In contrast, the embodiments depicted in FIGS. 5-6, provide an application that may reside on the user's own equipment (e.g., smart-phone, tablet, personal computer, other devices shown in FIG. 1, etc.) that may act to modify the photo prior to being shared/uploaded to a web-based service.

Embodiments shown in FIGS. 5-6 depict various user's photos that display advertisements in order to increase brand awareness via user endorsement. Accordingly, a user may endorse a brand by allowing that brand to replace the user's selected photo with a modified version that includes the brands mark(s) or imagery. For example, FIG. 6 depicts the insertion of an advertisement onto a photo associated with a user's social networking page, however, in this instance, it is not the user's profile photo.

In some embodiments, users may be compensated using any suitable approach (e.g., for uploads and per view). Rates of pay may be determined by an algorithm that rates the value of each image uploaded based on the demographics of the user base of the site upon which the image is ultimately viewed as compared to the stated/targeted demographics of the brand's campaign. Accordingly, the advertisers may pay the operators of the mobile application image advertising service.

It should be noted that the discussion and examples included herein are not limited to mobile devices and may be used in accordance with any suitable device, including, but not limited to, those shown in FIG. 1.

With reference to FIGS. 5-6, the term “user” may include, but is not limited to, a social network user, game player, company and/or individual utilizing or mobile application image advertisements. The terms “contact”, “viewer”, or “friend” may refer to a social network user viewing a “User's” profile and/or the advertisement on display. The “advertisement” may refer to a modified profile image or avatar that includes third party branding.

In some embodiments, and with respect to advertisement placement, a broker may engage advertisers to run advertisements for their brands on images uploaded by users. Contract terms are agreed upon 501, 502. Advertisers may describe the demographics of the target audience using any suitable parameter. Some of these may include, but are not limited to, interests, keywords, age, geographic location, language preferences, gender, age, etc. These preferences along with advertisement copy, and other constraints may be stored by social networking advertising process 10 (e.g. in server computing device 12) as preferences and standards 503.

In some embodiments, the broker may review, enhances, and prepare the advertisement components for use and activates the advertising campaign 504. The advertisement campaign may now be available for selection by users 505.

In some embodiments, and with respect to advertisement activation, social networking advertising process 10 may allow the user to download and install the an application (e.g. client-side application 10c1) and accept the terms and conditions thus allowing their selected image(s) to be replaced by modified versions containing advertisements. Accordingly, using the accompanying graphical user interface the user may define various preferences for categories or companies they are willing to endorse or are unwilling to endorse. In this way, using the accompanying graphical user interface the user may be presented with a list of categories 506 and brands 507 from which to choose and rank, such as outdoor, sports, food, beverage, autos, etc. Within each category, companies may be specifically included, excluded and/or ranked. The user may save their preferences in the application and any and all advertisements matching their choices may now be active 508.

In some embodiments, the application may send the user's preferences to server computing device 12 which may be stored 509 for business analysis and recovery purposes. When an image from the mobile device upon which the application is running is selected for sharing to other apps 510, the application may be found among the list.

In operations, upon selecting the application 511a, the user may be presented with a modified version of the image they are sharing 511b and may choose to accept and continue, and/or modify with a different format advertisement or different advertiser. Once selection of the format and the advertiser is complete, the user may be presented once more with the list of apps 511c to share the newly modified image. The user may continue normally, uploading the (now modified) image to whichever service or system as originally intended. Client-side application 10c1 may then send to server computing device 12 data identifying the before and after versions of the image, the advertiser chosen, and the system with which the image was ultimately shared 511d. This data may be used by server computing device 12 to scan the internet for use of the modified image 513 to assist in accounting and further analysis.

In some embodiments, and with regard to, advertisement presentation and viewing, when viewed by anyone using the service onto which the modified image was shared the image may be displayed in its modified form with the advertisement present.

In some embodiments, invoices may be delivered periodically and may be sent by the broker to the advertiser 514, 516 and payments may be made 517 for the services provided. Periodically payments are made by the broker to the users 519, 520 for endorsement of the advertisers' brands.

In some embodiments, social networking advertising process 10 may further include receiving, at the computing device, a response from a user of the social networking system indicating enrollment in advertisement generation via images uploaded to social networking pages and image sharing sites.

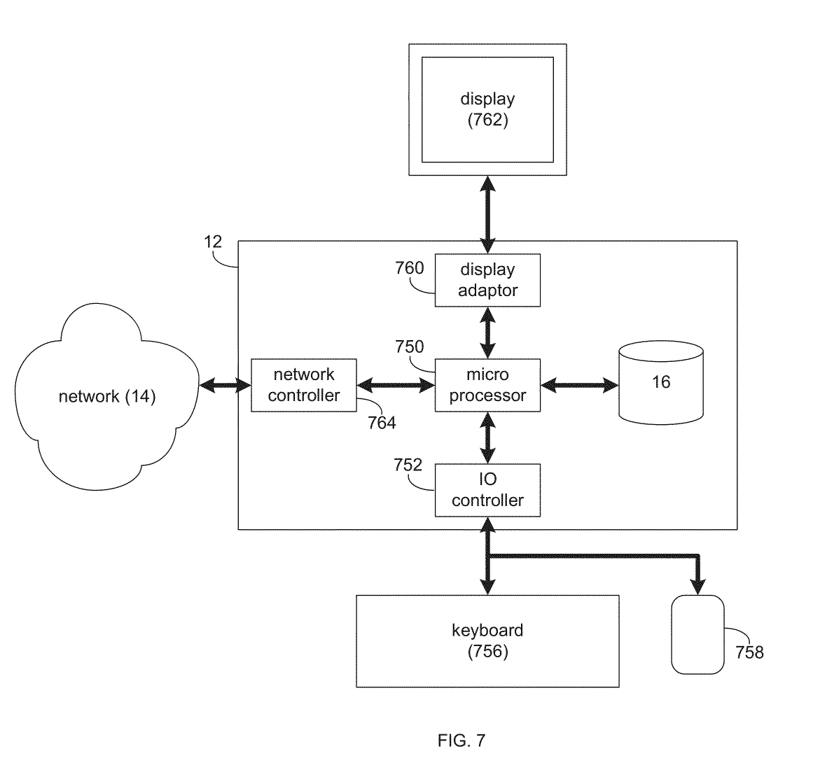

Referring also to FIG. 7, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, social networking advertising process 10 may be substituted for computing device 12 within FIG. 7, examples of which may include but are not limited to client electronic devices 28, 30, 32, 34.

Computing system 12 may include microprocessor 750 configured to e.g., process data and execute instructions/code for social networking advertising process 10. Microprocessor 750 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 752 may be configured to couple microprocessor 750 with various devices, such as keyboard 756, mouse 758, USB ports (not shown), and printer ports (not shown). Display adaptor 760 may be configured to couple display 762 (e.g., a CRT or LCD monitor) with microprocessor 750, while network adapter 764 (e.g., an Ethernet adapter) may be configured to couple microprocessor 750 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 350) of a general purpose computer/special purpose computer/other programmable data processing apparatus (e.g., computing device 12), such that the instructions, which execute via the processor (e.g., processor 200) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
receiving, at a computing device, one or more advertising parameters for use in a social networking system, wherein the one or more parameters are received from a brand owner;
receiving, at the computing device, a response from a user of the social networking system indicating enrollment in advertisement generation associated with a social networking page of the user;
determining a connection between the brand owner and the user of the social networking system based upon, at least in part, at least one of the one or more parameters and the response;
identifying an advertisement based upon at least one of the one or more parameters and the response; and
transmitting the advertisement to the social networking page of the user.

2. The computer-implemented method of claim 1 wherein the response indicates one or more user preferences regarding where the advertisement is placed on the social networking page of the user.

3. The computer-implemented method of claim 1 wherein the response identifies one or more brand owners for inclusion or exclusion on the social networking page of the user.

4. The computer-implemented method of claim 1 wherein the one or more advertising parameters includes target audience demographic information.

5. The computer-implemented method of claim 4 further comprising:
determining a value associated with the social networking page of the user based upon, at least in part, the target audience demographic information.

6. The computer-implemented method of claim 5 further comprising:
determining a compensation amount based upon the value associated with the social networking page of the user

7. The computer-implemented method of claim 1 further comprising:
transmitting a second advertisement to a contact of the user, wherein the second advertisement is based upon, at least in part, demographic information associated with at least one of the user and the contact.

8. A computing system including a processor and memory configured to perform operations comprising:
receiving, at a computing device, one or more advertising parameters for use in a social networking system, wherein the one or more parameters are received from a brand owner;
receiving, at the computing device, a response from a user of the social networking system indicating enrollment in advertisement generation associated with a social networking page of the user;
determining a connection between the brand owner and the user of the social networking system based upon, at least in part, at least one of the one or more parameters and the response;
identifying an advertisement based upon at least one of the one or more parameters and the response; and
transmitting the advertisement to the social networking page of the user.

9. The computing system of claim 8 wherein the response indicates one or more user preferences regarding where the advertisement is placed on the social networking page of the user.

10. The computing system of claim 8 wherein the response identifies one or more brand owners for inclusion or exclusion on the social networking page of the user.

11. The computing system of claim 8 wherein the one or more advertising parameters includes target audience demographic information.

12. The computing system of claim 11 wherein operations further comprise:
determining a value associated with the social networking page of the user based upon, at least in part, the target audience demographic information.

13. The computing system of claim 12 wherein operations further comprise:
determining a compensation amount based upon the value associated with the social networking page of the user

14. The computing system of claim 8 wherein operations further comprise:
transmitting a second advertisement to a contact of the user, wherein the second advertisement is based upon, at least in part, demographic information associated with at least one of the user and the contact.

15. A non-transitory computer-readable storage medium having stored thereon instructions that when executed by a machine result in the following operations:
receiving, at a computing device, one or more advertising parameters for use in a social networking system, wherein the one or more parameters are received from a brand owner;
receiving, at the computing device, a response from a user of the social networking system indicating enrollment in advertisement generation associated with a social networking page of the user;
determining a connection between the brand owner and the user of the social networking system based upon, at least in part, at least one of the one or more parameters and the response;
identifying an advertisement based upon at least one of the one or more parameters and the response; and
transmitting the advertisement to the social networking page of the user.

16. The computer-readable storage medium of claim 15 wherein the response indicates one or more user preferences regarding where the advertisement is placed on the social networking page of the user.

17. The computer-readable storage medium of claim 15 wherein the response identifies one or more brand owners for inclusion or exclusion on the social networking page of the user.

18. The computer-readable storage medium of claim 15 wherein the one or more advertising parameters includes target audience demographic information.

19. The computer-readable storage medium of claim 18 further comprising:
determining a value associated with the social networking page of the user based upon, at least in part, the target audience demographic information.

20. The computer-readable storage medium of claim 19 further comprising:
determining a compensation amount based upon the value associated with the social networking page of the user.
